(19) United States
(12) Patent Application Publication
(10) Pub. No.: US 2018/0109398 A1
(43) Pub. Date: Apr. 19, 2018

(54) MASTER COMMUNICATION DEVICE FOR A TOKEN NETWORK

(71) Applicant: PHILIPS LIGHTING HOLDING B.V., EINDHOVEN (NL)

(72) Inventors: TERESA ZOTTI, AACHEN (DE); JAN JOOST 'T HART, EINDHOVEN (NL); THEODORUS JACOBUS JOHANNES DENTENEER, EINDHOVEN (NL); GERHARDUS ENGBERTUS MEKENKAMP, VALKENSWAARD (NL); CHARLES LEONARDUS CORNELIUS MARIA KNIBBELER, EINDHOVEN (NL); GERARDUS CAROLUS VAN LOO, GELDROP (NL)

(21) Appl. No.: 15/567,151

(22) PCT Filed: Apr. 5, 2016
(86) PCT No.: PCT/EP2016/057428

§ 371 Date: Oct. 17, 2017

(30) Foreign Application Priority Data
Apr. 17, 2015 (EP) 15163954.9

(51) Int. Cl. H04L 12/417; H04L 12/40

(52) U.S. Cl. CPC H04L 12/417; H04L 67/12; H04L 12/40202

(57) ABSTRACT

Master communication device for a token network. The token network comprises a shared communication medium and at least one further master communication device coupled to the shared communication medium, the token network being arranged to pass frames and to execute a poll for master cycle. The master communication device is restricted in executing a poll for master cycle in specified cases especially if another device executed a poll for master for finding a new master communication device on the token network.

### FIELD OF THE INVENTION

The invention relates to the field of a master communication device for a token network, a method for a poll for master cycle, an integrated circuit device comprising a master communication device, a computer product for a processor and a token network.

### BACKGROUND OF THE INVENTION

Wired networks are used for communicating information. For certain types of wired networks the wire is used as a shared medium coupling all network nodes in the network to this wire. An exemplary use of a network having a shared medium is a Heating, Ventilation, Air conditioning and Cooling (HVAC) installation wherein various devices are coupled through one network. An exemplary network is a Building Automation and Control Network (BACnet) Master Slave/Token Passing (MS/TP) network. An example of such a network is a BACnet MS/TP network according to NEN-EN-ISO 16484-5:2012.

A response time may be defined as the time between the moment in time a master communication device would like to take the initiative for a transmission and the moment in time the master communication device receives a master token for taking the initiative for a transmission. A maximum response time may be defined as a worst case scenario response time.

WO 2007/143554 A2 discloses a proxy module comprising a token module, a poll for master (PFM) module and a confirmed request module. The token module is configured to manage communications regarding token passing and generate appropriate proxy responses for a remote network device that is the target device for a token passing communication. The PFM module is configured to manage communications regarding PFM requests and generate appropriate proxy responses for a remote network device that is the master at the time the PFM communication is sent. The confirmed request module is configured to manage communications regarding BACnet Data Expecting Reply requests, generate the appropriate proxy messages on the sending and receiving end, and forward the responses at an appropriate time.

A disadvantage of a BACnet MS/TP network according to NEN-EN-ISO 16484-5:2012 or a proxy module according to WO 2007/143554 A2 is that the maximum response time can increase greatly when multiple master communication devices are present on the network. This increase may even be disproportional to the amount of master communication devices on the network. This disadvantage of an increase of the maximum response time may increase even more if the amount of address gaps in the address range between master communication devices increase.

### SUMMARY OF THE INVENTION

The technical problem is to provide a solution to one or more of the above disadvantages.

A network node able to initiate a communication is called a master communication device. A network node not able to initiate a communication is called a slave communication device. A slave communication device is able to respond to a communication initiated by a master communication device. A master communication device and a slave communication device may respond to a communication initiated by another master communication device and addressed to them.

If network nodes transmit over the network at the same time these transmissions are lost. This loss of transmissions is called a collision. A way of reducing collisions on a network having a shared medium is to pass on a master token between master communication devices and allow a master communication device to initiate a transmission if and only if it has the master token. A master token cycle is defined as a period between accepting the master token from the network and the next time the master token is received from the network.

A token network comprises a master token chain and a master token. A master communication device may be part of the master token chain. The master token chain provides a logic order of master communication devices taking part in the master token chain. The master token is passed along from master communication device to master communication device according to the logic order, thereby forming an endless logic chain of master communication devices. The endless logic chain is named master token chain. The traditional token ring is a well-known example of a master token chain having a logic order of devices, while other network structures like a mesh or star may have a similar master token chain for sequentially addressing devices in a logic order for passing tokens. In the logic order a next master communication device is placed downstream from the current master communication device. By receiving the master token the next master communication device will be enabled to initiate a transmission after the current master communication device was enabled to initiate a transmission. A previous master communication device is placed upstream from the current master communication device. The previous master communication device was enabled to initiate a transmission before transferring the master token to the current master communication device.

In a token network having a shared medium, each node may be addressed with a unique identification code called the network address. The network addresses of the master communication devices may be ordered in a logic order to form a master token chain. A next master communication device of a current master communication device may be defined as a first master communication device having a network address on the token network encountered when counting upwards from the token network address of the current master communication device. A previous master communication device of a current master communication device may be defined as a first master communication device having a network address on the token network encountered when counting downwards from the token network address of the current master communication device.

The network address counting to find the next and previous master communication device for a current master communication device uses wraparound of the address counter at the edges of the address range used by master communication devices, thereby forming an endless logic chain of master communication devices for passing the master token called a master token chain.

In the case that the master token chain consists of one master communication device, it should be clear to the reader that a current communication device, a next communication device from the current communication device and a previous communication device from the current communication device are all and the same master communication device. In the case that the master token chain consists of two master communication devices, it should be clear to the reader that a next master communication device of the current communication device and a previous communication device of the current communication device are one and the same master communication device. When the master token chain consists of at least three master communication devices, it should be clear to the reader that a current master communication device, a next communication device of the current communication device and a previous communication device of the current master communication device are all separate master communication devices.

The network may be arranged to automatically recognize a new master communication device on the network. An example of a state diagram of an automatically recognizing a new master communication device is in FIG. 9-4 of NEN-EN-ISO 16484-5:2012. An example of a new master communication device configuring its network address is in 9.4.1 on page 3 of the Proposed Addendum bb to Standard 135-2012, BACnet A Data Communication Protocol for Building Automation and Control Networks, first public review January 2015.

A token network automatically recognizing a new master communication device should allow introducing new master communication devices to the master token chain. A new master communication device may be allowed on the master token chain through the use of a poll for master (PFM) action. A PFM action comprises the transmission of a PFM frame to a network location, for example identified by a network address, and waiting for a response on the transmitted PFM frame or for a timeout period to lapse. A PFM cycle of a master communication device already part of the master token chain may be defined as a cycle wherein all network locations, such as all network addresses, are polled for a new master communication device. The PFM cycle may be limited to a specific range of network locations, such as a specific range of network addresses. A PFM cycle therefore comprises at least one PFM action. This specific range may be all network locations, such as all network addresses, available on the token network or a sub-range of all network locations, such as all network addresses, available on the token network. To allow for a new master communication device to be recognized in a reasonable short period of time, the network locations, such as the network addresses, available on the token network or the network locations, such as network addresses, used by/reserved for master communication devices should be limited.

For this purpose, according to a first aspect, a master communication device for a token network is provided, the token network comprising a shared communication medium and at least one further master communication device coupled to the shared communication medium, the token network having a master token chain providing a logic order of master communication devices in the token network, the token network being arranged to pass a master token along the master token chain and to pass frames and to execute a poll for master cycle, a next master communication device being downstream from the master communication device in the master token chain, a previous master communication device being upstream from the master communication device in the master token chain, the master communication device comprising: a pass unit arranged to pass the master token to the next master communication device and set the master communication device in a listening state when passing the master token; an accept unit arranged to accept the master token from the previous master communication device and set the master communication device in a transmission state when accepting the master token; and a poll for master unit arranged to execute the poll for master cycle if the master communication device is in the transmission state, the poll for master cycle comprising at least one transmission of a poll for master frame to the token network, the poll for master unit being arranged to restrict said execution of the poll for master cycle when at least one poll for master frame was present on the shared medium during that the master communication device was in the listening state preceding the transmission state.

In the context of this application the word restrict should be read as one of the words out of a group of words consisting of prohibit and limit. For example the poll for master unit may be arranged to prohibit said execution of the poll for master cycle when at least one poll for master frame was present on the shared medium during that the master communication device was in the listening state preceding the transmission state. As another example the poll for master unit may be arranged to limit said execution of the poll for master cycle when at least one poll for master frame was present on the shared medium during that the master communication device was in the listening state preceding the transmission state. In the context of this application the word limit should be read as that the amount of PFM actions is limited to an amount which prevents the master communication device to increase the maximum response time to unacceptable levels.

The combined effect of the features of the claims is that multiple master communication devices on a token network increase the maximum response time less than in the prior art system. The measures of the claims may even increase the maximum response time proportional to the amount of master communication devices on the network. The measures may have the further effect that master communication devices on the network increase the maximum response time only linear.

In an embodiment a master token count threshold should be understood as a positive integer value. In an embodiment a reset of a parameter sets the parameter to a zero value. In an embodiment a set of a parameter sets the parameter to a non-zero value. In an embodiment a set of a parameter sets the parameter to a positive integer value.

A master communication device may be assigned a range of network addresses to poll for a new master communication device when multiple master communication devices are present on a token network. Ranges assigned to different master communication devices on the token network should cover the complete address range of the token network assigned for master communication devices. An improvement would be to assign non overlapping ranges of network addresses to the multiple master communication devices on the token network.

An example of assigning non overlapping network address ranges to multiple master communication devices on the token network is to assign to each master communication device the network address between the network address of the master communication device and the network address of the next master communication device. As a consequence a master communication device having a network address one lower compared to its next master communication device has no network address range assigned and therefore will not execute a PFM cycle or alternatively may have a PFM cycle which is instantly done when executed without the execution of any PFM action.

In an embodiment a poll for master or a PFM action may be a poll for master as defined by BACnet in paragraph 9.5.6.5 of NEN-EN-ISO 16484-5:2012.

In an embodiment a token network allows master communication devices as well as slave communication devices on the token network. In an embodiment a master communication device is able to communicate with another master communication device as well as a slave communication device.

In an embodiment a master communication device comprises a detect unit for detecting a PFM frame when in a listening status. The next time the master communication device acquires the master token, a PFM cycle is not initiated or limited in time because the detect unit detected at least one PFM frame. The embodiment complies with a protocol of the token network like BACnet. Further the protocol may not need to be extended with any proprietary addition. This embodiment therefore has a direct measurement of the presence of a PFM frame on the shared medium.

It should be clear to the reader that a further master communication device may be any master communication device, for example a next or previous master communication device from the current master communication device, from the master token chain except the current master communication device. In an embodiment a master communication device decreases a master token counter value when a PFM frame is detected by a detect unit. The next time the master communication device acquires the master token, a PFM cycle is not initiate or limited in execution length because the master token counter value was decreased such that the master token counter value is not larger or equal to a master token count threshold if the master token count threshold is initialized to a positive integer value. The preferred value of the master token count threshold for this embodiment is two or higher. When the master token count threshold is set to one, each master executes a PFM cycle each time this master accepts the master token. Setting the master token count threshold to zero or one for the embodiment are not preferred settings and result in a different behavior of the embodiment. The embodiment complies with a protocol of the token network like BACnet. A protocol in accordance with this embodiment is advantageous in that it is compatible with the existing BACnet protocol and does not require proprietary additions.

In a further embodiment the decrease corresponds to a master token counter value reset. This may provide ease of implementation. This may provide a smaller implementation.

In an embodiment the decrease corresponds to a master token counter value decrement. This may provide a reduction of the gap in time between two masters performing a PFM.

In an embodiment a master token counter value decrease is further depending on the value of the master token counter. This provides that the master token counter value is only decreased when needed to prevent or limit a PFM cycle next time the device comes in the transmission state. This may provide a reduction of the gap in time between two masters performing a PFM.

In an embodiment the master token count threshold has a value equal or higher than two and said decrease is to a no-poll for action value only if the master token counter value is higher than the no-poll for action value, the no-poll for action value being defined as the master token count threshold minus two.

In a further embodiment the master token decrease is to a value preventing or limiting a PFM cycle next time the device comes in the transmission state and will set-up the value for a PFM cycle to occur when the device comes in the transmission state the time after the next time. This provides that the master token counter value is only decreased when needed to prevent or limit a PFM cycle next time the device comes in the transmission state. This provides that the gap in time between two masters performing a PFM may be reduced.

In an embodiment a master token count threshold is defined by a vector of values. A first value may define a first threshold, a second threshold, which is higher than the first value, may define a second threshold and continued for any other values present in the vector. If a master token counter value is below the first threshold, no PFM action is allowed. If a master token counter value is between the first and second threshold, limited PFM actions are allowed. And so on for other thresholds. And if a master token counter value is above the last threshold, PFM actions are allowed.

In an embodiment a master communication device unit resets a poll for master skip flag when a master token is passed to the network. Subsequently the communication device listens to the network until the communication device regains the master token and when registering a poll for master frame sets the poll for master skip flag. During the next time the master communication device comes in the transmission state a PFM cycle by the master communication device is prevented or limited when the poll for master skip flag is set.

In this embodiment the master communication device complies with the protocol of the token network having a shared medium and using a poll for master cycle to automatically recognize a new master communication device on the network. This embodiment may provide that the protocol does not need to be extended with a proprietary addition.

In an embodiment a PFM token is provided. In this embodiment a master communication device may only be allowed to execute a PFM cycle in case the master communication device has the PFM token, has the master token and the master token counter value is larger or equal to a master token count threshold. This provides a simplified implementation and further may provide that the gap in time between two masters performing a PFM action may be limited.

In an embodiment a master communication device uses a PFM token and a master token, the PFM token and the master token being passed in one frame over a shared medium and/or a PFM token and a master token being accepted in one frame over the shared medium. A special frame type could be defined for this passing of the tokens. Passing the PFM token and the master token at the same time provides combining both tokens in one frame and thereby limiting the amount of bandwidth on the network used for passing tokens.

In an embodiment a master communication device uses a PFM token and a master token, a PFM token and a master token being passed in separate frames, preferably in two separate frames, over the shared medium and/or the PFM token and the master token being accepted in separate frames, preferably in two separate frames, over the shared medium. A special frame type could be defined for passing of the PFM token. This provides a clean communication in a sense that information concerning the PFM token is not mixed with other information in one frame. This may provide further that the PFM token can be passed only to masters which are able to handle a PFM token.

In an embodiment a master communication device uses a PFM token. When the PFM token is lost due to a fault on the token network or of a master communication device the PFM token may need to be regenerated. The regeneration of the PFM token may be done in the same way as the regeneration of the master token is done. This provides one regeneration mechanism for two different tokens. An example of regenerating a master token is a regeneration of a token in a BACnet MS/TP network as specified in 9.4 and 9.5.6.7 of NEN-EN-ISO 16484-5:2012.

In an embodiment a master communication device is a master node for a BACnet MS/TP network as specified in NEN-EN-ISO 16484-5:2012. In this embodiment the master token count threshold may be equal to, may be shifted from or may be depending on the Npoll parameter from the BACnet MS/TP network. In this embodiment the master token is the token from the BACnet MS/TP network. In this embodiment the network address of the master communication device on the BACnet MS/TP network is a MAC address.

In an embodiment multiple master communication devices may be on the same token network, which uses the BACnet MS-TP network protocol as specified in NEN-EN-ISO 16484-5:2012, could have different values for the Npoll parameter. This provides that the Npoll parameter may be adaptable to the size of the network address range assigned to poll for a new master. For example if the assigned network address range of a first master communication device is large compared to the assigned address range of a second master communication device the Npoll value of the first master communication device can be set to a lower value compared to that of the second master communication device such that the change of a network address to be polled for a new master may be equal for both address ranges. This allows that if the Npoll parameters are selected appropriately for each master communication device, the changes for each network address to be polled for a new master may be substantially equal.

Advantageously, in an embodiment a token network is selected from the group of token networks consisting of an ARCnet, an IEEE802.4 and a MODbus plus, however the invention is not limited to application to these token networks.

In an embodiment a master communication device is configurable or fixed as master communication device. Having a configurable master communication device provides that during fabrication, installation and/or operation a master communication device can be configured to behave as a master only, a slave only or a master/slave combination or a subset thereof. Having a fixed master communication device provides that the implementation of the master communication device may be simplified. Having a fixed master communication device unit may further provide that the implementation requires less logic. Having a fixed master communication device unit may provide that the installation of the master communication device may be simplified.

In an embodiment a master communication device uses as a physical layer one of the group consisting of an RS-232 physical layer, an RS-485 physical layer, an RS-422 physical layer, an EIA-485 physical layer, an IEEE 802.3 physical layer, an ISO 8802-2 Type 1 protocol and/or Ethernet physical layer. Other physical layers are considered by the inventors.

In an embodiment a master token count threshold is predefined. This provides a simplification of design and implementation and thereby reducing the logic.

In an embodiment an increase of a master token counter value is an increment.

In an embodiment a master communication device further comprises a data transmission and reception unit and one or more units of a group of units consisting of a switch unit, a sensor unit, a light emitting unit and/or a data storage unit, the one or more units being coupled for data to the data transmission and reception unit. This provides coupling a unit of the group to a data transmission and reception unit providing access from and/or to the network.

In an embodiment a poll for master cycle is split over a plurality of periods a master communication device is in a transmission state. This provides for a reduction of the maximum response time and/or the maximum time a token cycle takes. In an embodiment a PFM cycle is split such that at most one PFM action is done every time the master communication device is in the transmission state.

In an embodiment a poll for master cycle is split over a plurality of periods a master communication device is in a transmission state. This provides a reduction of the maximum response time and/or the maximum time a token cycle takes. In an example of this embodiment during a poll for master cycle each time the master communication device is in the transmission state only one PFM action is done.

In an embodiment a poll for master cycle is split over a plurality of periods a master communication device is in a transmission state depending on the amount of data transmissions on the token network. This provides for a reduction of the maximum response time and/or the maximum time a token cycle takes. If the amount of data transmissions on the token network exceed a data transmission threshold the next time the master communication device is in the transmission state the execution of a PFM cycle can be postponed to a next time the master communication device is in the transmission state.

In an embodiment a master communication device comprises a coupling unit to couple to a further communication device. The coupling unit is arranged to relay, route and/or repeat information between the token network and the further communication unit.

The further communication device may be arranged to communicate with an IP network. This further communication unit provides access to an IPv4 and/or an IPv6 network.

This further communication unit may be arranged to also be a duplicate of the master communication device and thereby providing a relaying, routing or repeating node coupling two token networks.

A second aspect is a method for a poll for master cycle for the token network comprising a shared communication medium and at least one further master communication device coupled to the shared communication medium, the token network having a master token chain providing a logic order of master communication devices in the token network, the token network being arranged to pass a master token along the master token chain and to pass frames, a next master communication device being downstream from the master communication device in the master token chain, a previous master communication device being upstream from the master communication device in the master token chain, wherein the method comprises the steps of: passing a master token to the next master communication device on the token network by a master communication device on the token network and thereby setting the master communication device in a listening state; accepting the master token from the previous master communication device on the token network by the master communication device and thereby setting the master communication device in a transmission state; and executing the poll for master cycle if the master communication device is in the transmission state, the poll for master cycle comprising at least one transmission of a poll for master frame to the token network, the poll for master unit being arranged to restrict said execution of the poll for master cycle when at least one poll for master frame was present on the shared medium in the listening state preceding the transmission state.

A further aspect is an integrated circuit device comprising a master communication device according to an embodiment or arranged to conduct a method for a poll for master cycle.

A further aspect is a computer program product for a processor of a master communication device, or a processor of an integrated circuit device, which program is operative to cause the processor to perform the functions according to an embodiment or execute the steps of the method according to an embodiment.

A further aspect is a token network having a shared medium and arranged to execute a poll for master cycle comprising a plurality of master communication devices; at least one master communication device operating according to the method of an embodiment coupled to the token network and at least one further master communication device; or at least one integrated circuit device according to an embodiment coupled to the token network and at least one further master communication device.

The inventors have found that in the embodiments described above for a switch and a light coupled to each other an acceptable limit of the maximum response time for a change of the switch and a corresponding response of the light may be less than 1000 ms, 500 ms, 300 ms or 200 ms. A data transmission is defined as the total transfer of the data information from a sending master communication device to a receiving master communication device. Depending on the protocol a data transmission may incorporate an acknowledge back to the sending master communication device acknowledging the reception of the transfer of data by the receiving master communication device. The inventors have found that a data transmission of a master communication device can take about 2 ms.

The inventors have found that in embodiments described above a PFM action duration may range from 5 ms to 60 ms, preferably from 10 ms to 40 ms, more preferably 15 ms to 30 ms, most preferably 17 to 23 ms. A PFM action may be defined by a protocol, such as the BACnet MS-TP network protocol as specified in NEN-EN-ISO 16484-5:2012. Herein the PFM action duration is defined by the addition of a transmission duration of a PFM frame and the minimum time for Tusage_timeout, wherein Tusage_timeout is defined in paragraph 9.5.3 and set to 20 ms. The inventors have found that a PFM action duration may be pressing much heavier on the maximum response time budget compared to data transmission durations of a master communication device. A smaller range for the PFM action duration may be less pressing on the maximum response time budget. A larger range for the PFM action duration may relax the timing requirements for a master communication device, which needs discovery.

The inventors have found that a token network for example for HVAC applications, like BACnet, may be suitable for lighting applications when the maximum response time is limited. The inventors have further found that a token network using the inventive concept may be suitable for lighting applications when the maximum response time is limited to one of the maximum response time ranges given above.

In an embodiment a master communication device is arranged to be a BACnet MS/TP master network node.

Further preferred embodiments of the master communication device and method are given in the appended claims, disclosure of which is incorporated herein by reference.

A method may be implemented on a computer as a computer implemented method, or in dedicated hardware, or in a combination of both. Executable code for a method may be stored on a computer program product. Examples of computer program products include memory devices, optical storage devices, integrated circuits, servers, online software, etc. In an embodiment, the computer program product comprises non-transitory program code means stored on a computer readable medium for performing a method when said program product is executed on a computer.

In an aspect, the computer program comprises computer program code means adapted to perform a method according to the invention when the computer program is run on a processor. In an embodiment the computer program is embodied on a computer readable medium.

In another aspect a method of making the computer program available for downloading is provided. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 schematically shows an example of an embodiment of a trunk control network for a lighting system.

FIG. 2 schematically shows an example of an embodiment of a master communication device and a token network.

FIG. 3 schematically shows an example of an embodiment of a master communication device having a detect unit and a token network.

FIG. 4 schematically shows an example of an embodiment of a flowchart of a first embodiment.

FIG. 5 schematically shows an example of an embodiment of a flowchart of a second embodiment.

FIG. 6 schematically shows an example of an embodiment of a flowchart of a third embodiment.

FIG. 7 schematically shows an example of an embodiment of a flowchart of a fourth embodiment.

FIG. 8 schematically shows a block diagram of an integrated circuit device.

FIG. 9 schematically shows an example of an embodiment of a computer program product and/or non-transitory computer readable storage medium.

FIG. 10 schematically shows an example of an embodiment of a token network.

FIG. 11 schematically shows an example of state diagram of an embodiment of a token network.

The figures are purely diagrammatic and not drawn to scale. In the Figures, elements which correspond to elements already described may have the same reference numerals.

### List of Abbreviations:

LSt Listening State

MAC Medium Access Control

MCD Master Communication Device

MT Master Token

MTC Master Token Counter

MTCV Master Token Counter Value

NS Next Station i.e. Next master communication device

PFM Poll For Master

PFMF Poll For Master Flag

PFMT Poll For Master Token

Rx Receive

SCD Slave Communication Device

PFM SF Poll For Master Skip Flag

TN Token Network

TS This Station i.e. Current master communication device

TSt Transmission State

Tx Transmit

### List of Reference Numerals:

1, 1′ Token network

2, 2′ Shared medium

3 Aggregating communication network

4 Network node with luminaire

5 Network node with sensor

6 Network node with luminaire and sensor

7 Network router node

10 Trunk control network

100 Master Communication Device

101 Pass unit

102 Detect unit

103 Accept unit

104 Poll for master unit

105 Device State unit

110 To Listening signal

111 To Transmission signal

112 PFM Prevent signal

113 Current State signal

120 Pass MT signal

121 Rx Frame signal

122 Accept MT signal

123 PFM Action signal

151 Shared medium

152 Coupling between shared medium and master communication device

200 Flowchart first embodiment

201,301,401,501 Start

402 Reset PFM SF

203, 303, 403 Listen to the TN

204, 304, 404 Increment MTCV

205, 305, 405, 505 Transmission of data

406 Check if PFM SF is set

307 Check if PFMT was received

208, 308, 408 Check if MTCV≥Npoll

209, 309, 409 Check if NS-TS-1=0

210, 310, 410 Perform PFM cycle

211, 311, 411 Check if PFM cycle is completed

212, 312, 412 Set MTCV to 0

224, 324, 424 End

313 Reset PFMF

314 Check if PFMF is set

316 Set PFMF

220 Set MTCV to 0

221, 321, 421 Pass MT to TN

322 Pass MT and PFMT to TN

300 Flowchart second embodiment

400 Flowchart third embodiment

420 Set PFM SF

500 Flowchart fourth embodiment

530 Pass MT

531 Detect PFMF

532 Accept MT

533 Check PFM detected

534 Possible PFM cycle

600 Integrated Circuit Device

610 Integrated Circuit Die

620 Master Communication Device

622, 624, 626 Further devices

630 Coupling device

700 Computer Program Product and/or Non-transitory Computer

Readable Storage Medium

710 Writeable part

720 Computer Program

800 Token Network

801, 801′ Master Communication Device

802 Master Communication Device/Slave Communication Device

combination

803 Slave Communication Device

810, 810′, 810″, 810′″ Communication coupling

811 Shared Medium

900 State diagram of a master communication device

910, 910′, 910″ TSt, Transmission state

911 Transmission state period

920, 920′, 920″ LSt, Listening state

930 Progress of time

### DETAILED DESCRIPTION OF EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

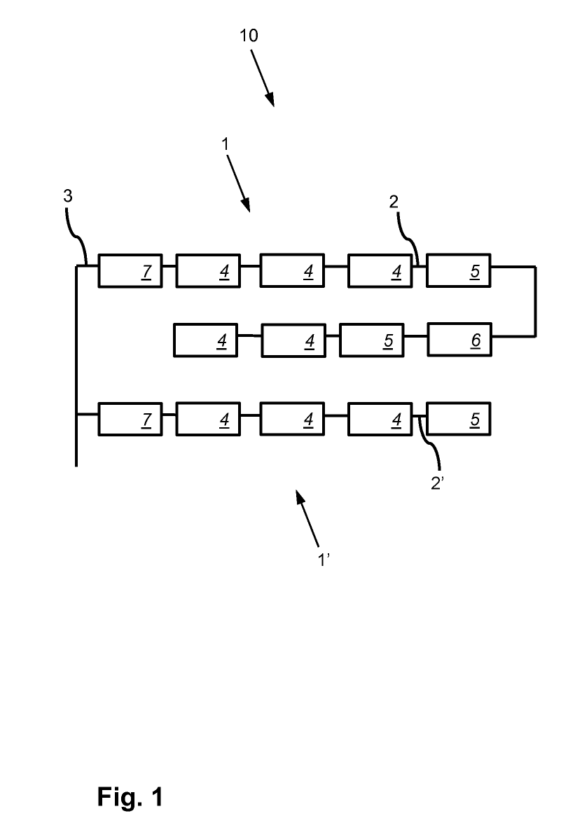

FIG. 1 schematically shows a trunk control network 10 for a lighting system. The trunk control network comprises an aggregating network 3, a first token network 1, 1′, 1″ and a second token network 2, 2′, 2″. The first and second token network are coupled to the aggregating network by respective edge routers 7 for allowing access to and from the token network to other networks coupled to the aggregating network. FIG. 1 shows an example of a lighting network application of the token network. The first token network therefore comprises parts of the lighting system, which are all optional. The first token network in the example comprises the edge router, a luminaire 4, a sensor 5 and a luminaire-sensor combination 6. The luminaire can be implemented as slave communication device. The sensor can be implemented as master communication device. The edge router can be implemented as master communication device. The luminaire-sensor combination can be implemented as master/slave communication device.

The aggregating network of FIG. 1 aggregates the separate token networks to let the two token networks share information as well as to make the token networks accessible to the outside world.

The token network comprises a master token, which is handed from master communication device to master communication device to allow masters on the token network to take the initiative to start a transmission and thereby the exchange of information.

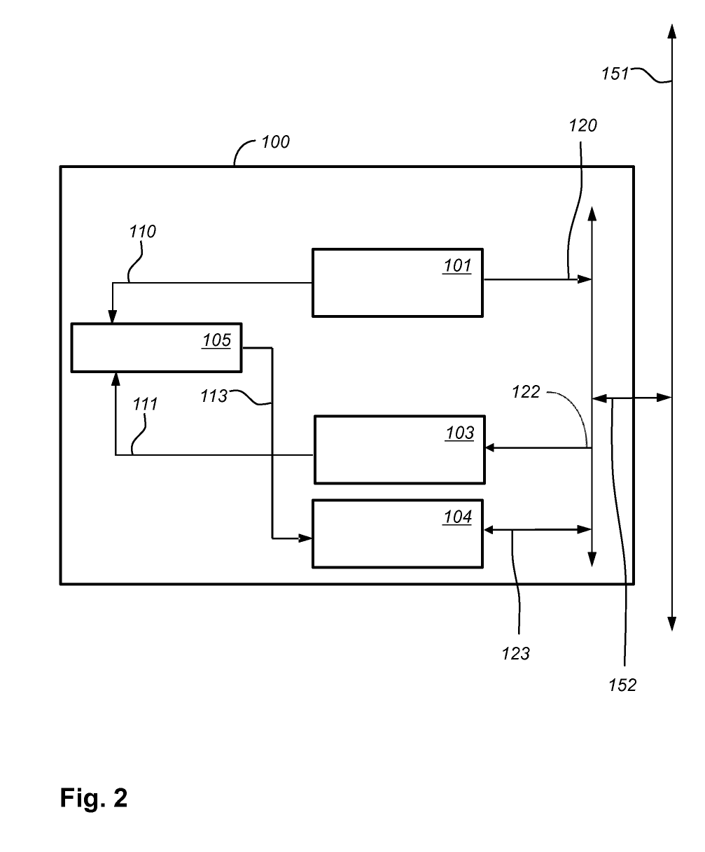

FIG. 2 schematically shows a master communication device 100 and a token network 150. The token network comprises a shared medium 151 and a coupling 152 coupling the shared medium and the master communication device.

The master communication device comprises a pass unit 101, an accept unit 103, a poll for master unit 104 and a device state unit 105. The pass unit passes a master token 120 to the token network. The accept unit accepts master tokens 122 from the token network. The poll for master unit performs PFM actions 123 on the token network.

In the device state unit a current state is kept. The current state can be a listening state or a transmission state. The pass unit sets the device state unit in the listening state 110 when the master token is passed to the token network. The accept unit sets the device state unit in the transmission state 111 when the master token is accepted from the token network. The poll for master unit is provided with the current state. The poll for master unit is restricted from executing a PFM action or limited in the amount of PFM actions during the time the current state is the transmission state and at least one PFM action was present in the listening state preceding the current transmission state.

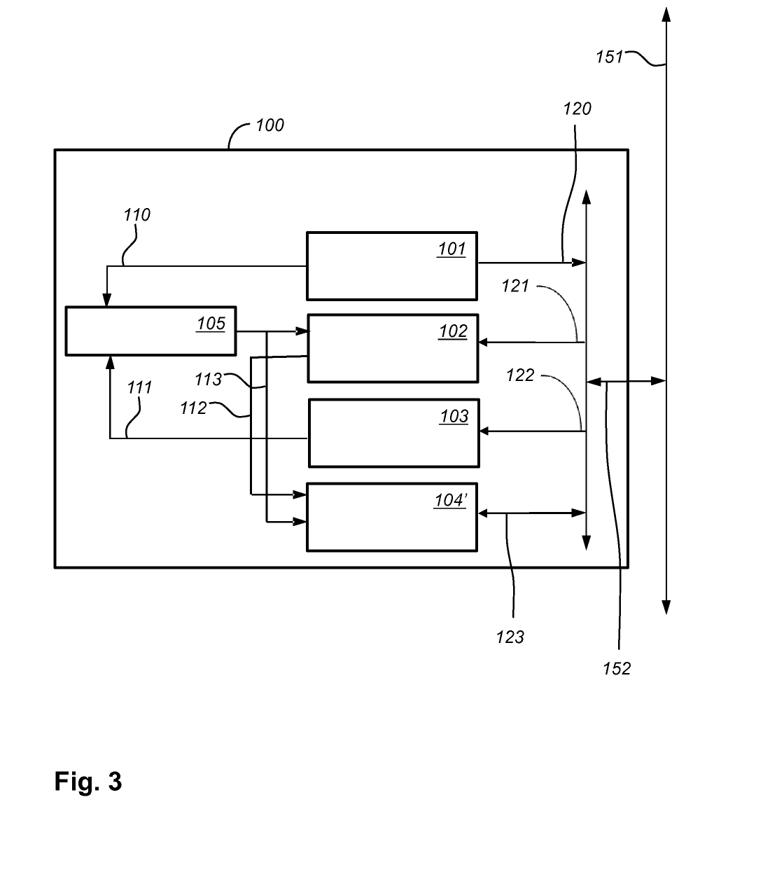

FIG. 3 schematically shows a further master communication device 100 and a token network 150. The master communication device of FIG. 3 comprises a detect unit and a poll for master unit 104′ with an additional input. The detect unit is provided with the current state 113. The detect unit filters the received frames and sets the PFM prevent signal 112 during that the current state is next time in the transmission state when the current state is the listening state and a poll for master frame was detected.

The poll for master unit is provided with the current state and the PFM prevent signal. The poll for master unit 104′ is allowed to start a poll for master during the time the current state is the transmission state and the PFM prevent signal is absent.

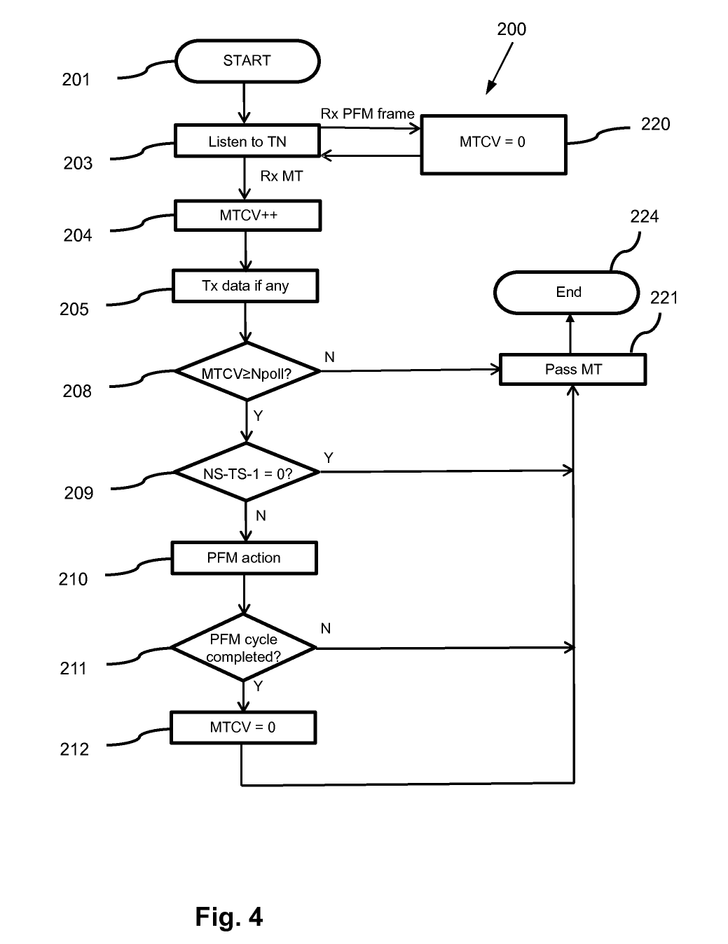

FIG. 4 schematically shows a flowchart of a first embodiment 200 having a reset of a Master Token Counter Value (MTCV). From a start 201 the master communication device starts listening to the bus 203. If during listening a PFM frame not destined for the current master communication device is received the MTCV is set to zero 220 and listening to the token network 203 is continued. If during listening a master token is received the MTCV is incremented 204 and next, if there is data available at the master for transmission then that data is transmitted 205 from the master to at least one other device on the network. After data transmission a check is performed if the MTCV is equal or higher than the Npoll value 208. If no then the master token is passed 221 to the token network. If yes then a following check is performed if a network address range is assigned to the master communication device 209 by checking the network address of the master communication device and the network address of the next master communication on the token network. If no network address range was assigned (indicated as Y) then the master token is passed 221 to the token network. If a network address range was assigned (indicated as N) a PFM action 210 is performed. After the PFM action a check is performed if a PFM cycle is completed 211. If the PFM cycle was not completed then the master token is passed 221 to the token network. If the PFM cycle was completed then the MTCV is set to zero 212 where after the master token is passed 221 to the token network. If the master token is passed to the shared medium destined to a next master communication device, the end 224 state is reached.

In the event that a PFM frame was present on the shared medium the response time may be increased. To reduce any further increase of a response time or even exceeding a maximum response time a MTCV of a master communication device is set to zero by the master communication device executing the flowchart of FIG. 4. This set causes the master communication device to not be able to execute a PFM action during the following transmission state of the master communication device.

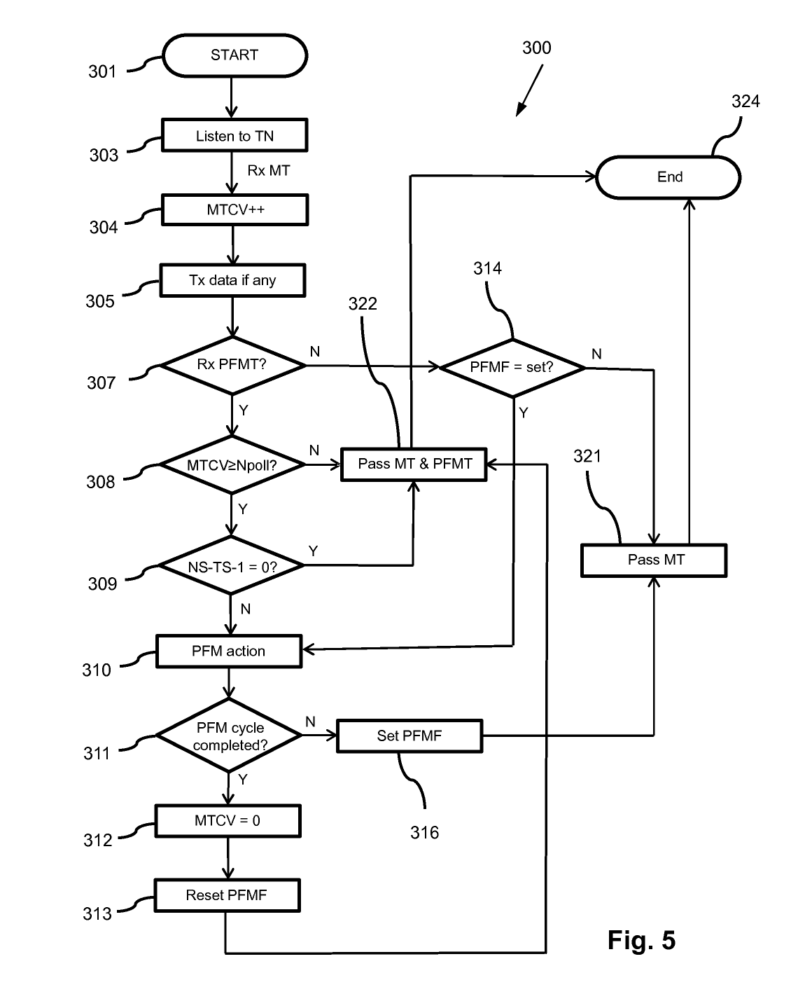

FIG. 5 schematically shows a flowchart of a second embodiment 300 having a Poll For Master Token (PFMT). From a start 301 the master communication device starts listening to the bus 303. If during listening a master token was received the MTCV is incremented 304 where after if there is data available at the master for transmission the data is transmitted 305 from the master to at least one other device on the network. After data transmission a check is performed if the PFMT was received 307. If the PFMT was not received then a check is performed if the PFMF is set 314. If the PFMF is not set then the master token is passed 321 to the token network. If the PFMF is set then a PFM action is performed 310.

If the PFMT was received then a check is performed if the MTCV is equal or higher than the Npoll value 308. If no then the master token and the PFMT are passed 322 to the token network. If yes then a following check is performed if a network address range is assigned to the master communication device 309 by checking the network address of the master communication device and the network address of the next master communication on the token network. If no network address range was assigned (indicated as Y) then the master token and the PFMT are passed 322 to the token network. If a network address range was assigned (indicated as N) the PFM action 310 is performed. After the PFM action a check is performed if a PFM cycle is completed 311. If the PFM cycle is not completed then the PFMF is set where after the master token is passed 321 to the token network. If the PFM cycle is completed then the MTCV is set to zero 312 and the PFMF is reset 313 where after the master token is passed 321 to the token network. If the master token is passed or the master token and poll for master token are passed to the shared medium destined to a next master communication device, the end 324 state is reached.

To reduce any further increase of a response time or even exceeding a maximum response time a PFMT is passed between master communication devices. The PFMT may prevent multiple masters to execute a PFM action in the same time frame as seen for a response time of a master communication device.

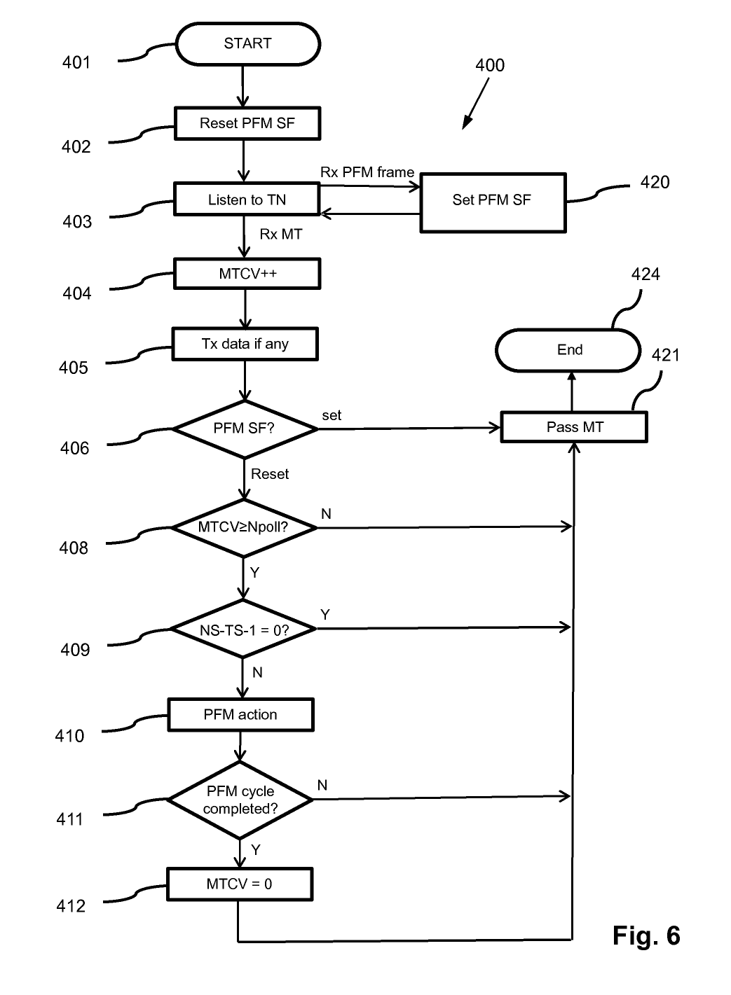

FIG. 6 schematically shows a flowchart of a third embodiment 400 having a Poll For Master Skip Flag (PFM SF). From a start 401 the master communication device resets the PFM SF 402 where after the master communication device starts listening to the bus 403. If during listening a PFM frame is received the PFM SF is set 420 and listening to the token network 403 is continued. If during listening a master token is received the MTCV is incremented 404 and if there is data available at the master for transmission then that data is transmitted 405 from the master to at least one other device on the network.

After data transmission a check is performed if the PFM SF is set. If the PFM set is set then the master token is passed 421 to the token network. If the PFM SF is not set then a check is performed if the MTCV is equal or higher than the Npoll value 408. If no then the master token is passed 421 to the token network. If yes then a following check is performed if a network address range is assigned to the master communication device 409 by checking the network address of the master communication device and the network address of the next master communication on the token network. If no network address range was assigned (indicated as Y) then the master token is passed 421 to the token network. If a network address range was assigned (indicated as N) a PFM cycle 410 is performed. After the PFM cycle a check is performed if a PFM cycle is completed 411. If the PFM cycle was not completed then the master token is passed 421 to the token network. If the PFM cycle was completed then the MTCV is set to zero 412 where after the master token is passed 421 to the token network. If the master token is passed to the shared medium destined to a next master communication device, the end 424 state is reached.

In the event that a PFM frame was present on the shared medium the response time may be increased. To reduce any further increase of a response time or even exceeding a maximum response time a PFM SF of a master communication device is set by the master communication device executing the flowchart of FIG. 6. This set causes the master communication device to not be able to execute a PFM action during the following transmission state of the master communication device.

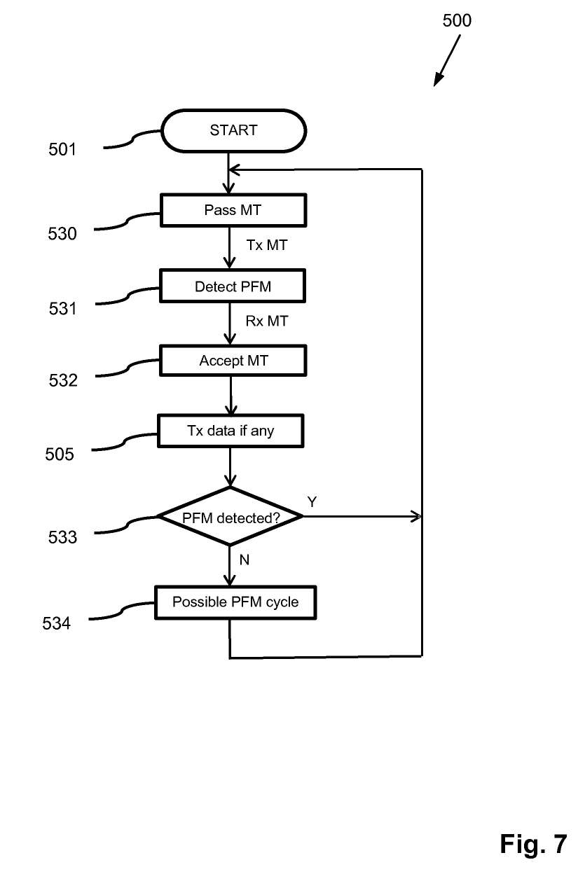

FIG. 7 schematically shows an example of an embodiment of a flowchart of a fourth embodiment 500. From a start 501 a master communication device passes a MT 530 to a token network. After passing the master communication device listens to the token network and detects if a PFM is present. If during listening the MT is received by the master communication device the master communication device accepts the MT 532. After accepting any data to be transmitted is transmitted 505. If there is data available for transmission at the master then that data is transmitted and a check is done if a PFM was received during the previous period the master communication device was not having the MT 533. If yes then the MT is passed 530 and the flowchart starts at the beginning If no then the master communication device may decide to perform a PFM cycle or part of a PFM cycle 534, such as one PFM action. After performing a PFM cycle or part of a PFM cycle the MT is passed to the token network 530 and the flowchart starts at the beginning

In the event that a PFM frame was present on the shared medium the response time may be increased. To reduce any further increase of a response time or even exceeding a maximum response time a master communication device restricted in executing a PFM action as shown in FIG. 7. This restriction of the master communication device causes the master communication device to not be able to execute a PFM action during the following transmission state of the master communication device.

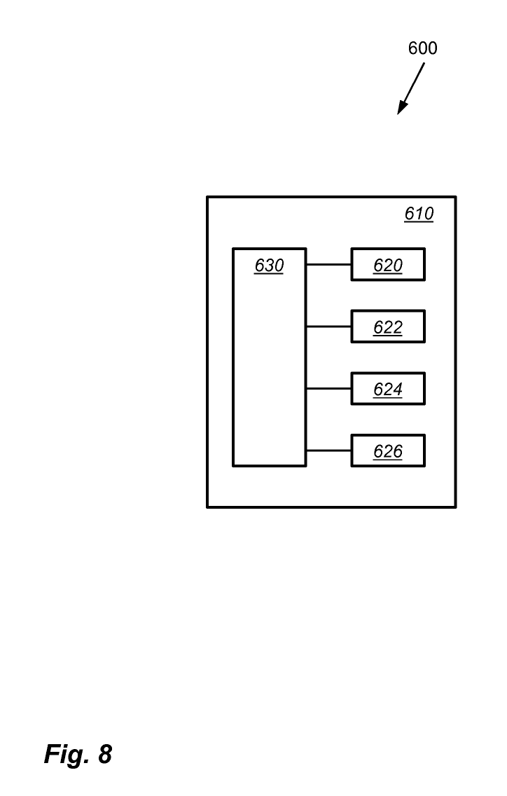

FIG. 8 schematically shows a block diagram of an integrated circuit device 600. The integrated circuit device comprises an integrated circuit die 610. The integrated circuit die comprises at least a master communication device 620 and several optional devices 622, 624, 626 and at least in case of one or more optional devices a coupling device 630. The coupling device electrically couples the master communication device with the several optional devices for communication between the devices.

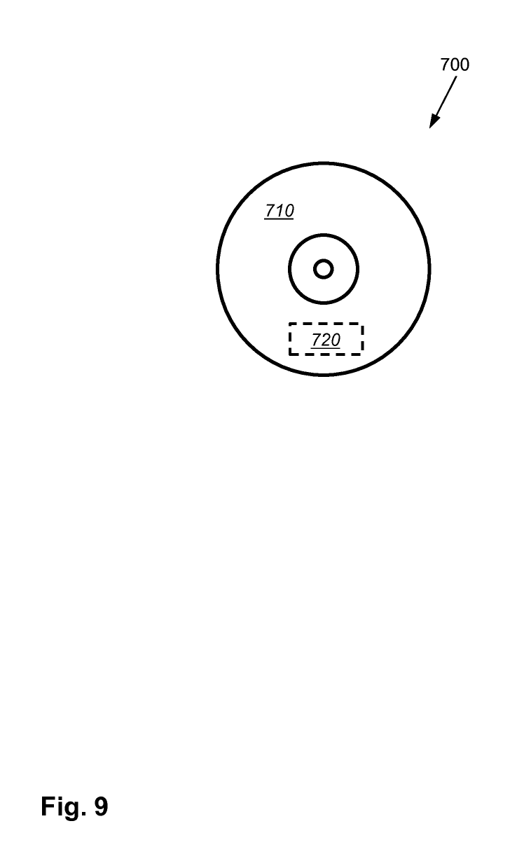

FIG. 9 schematically shows an example of an embodiment of a computer program product, computer readable medium and/or non-transitory computer readable storage medium 700 having a writable part 710 comprising a computer program 720, the computer program comprising instructions for causing a processor system to perform a method of an embodiment. The computer program may be embodied on the computer readable medium as physical marks or by means of magnetization of the computer readable medium. However, any other suitable embodiment is conceivable as well. Furthermore, it will be appreciated that, although the computer readable medium 700 is shown here as an optical disc, the computer readable medium 700 may be any suitable computer readable medium, such as a hard disk, solid state memory, flash memory, etc., and may be non-recordable or recordable. The computer program comprises instructions for causing a processor system to perform said method of an embodiment.

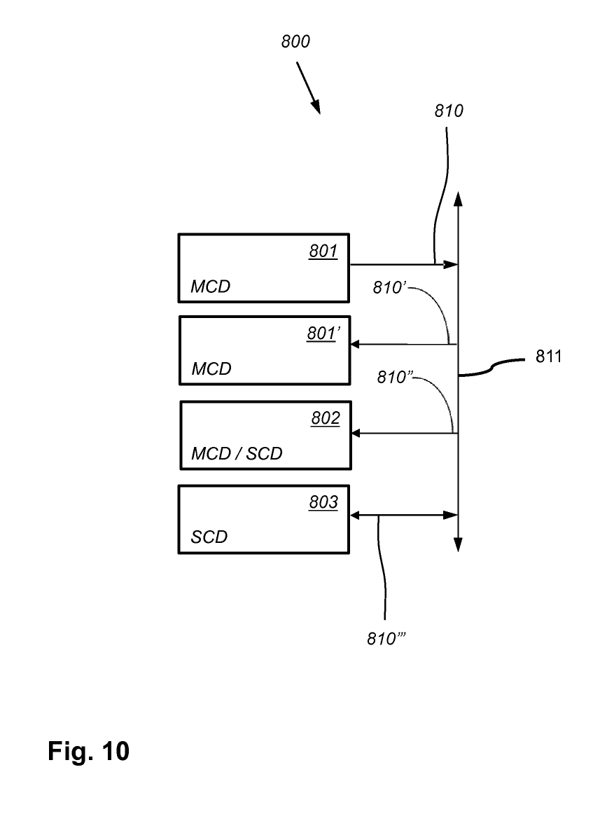

FIG. 10 schematically shows an example of an embodiment of token network 800. The token network comprises a shared medium 811 and several optional devices 801, 801′, 802, 803 according to embodiments coupled 810, 810′, 810″, 810′″ to the token network.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. For example, a given step may not have finished completely before a next step is started.

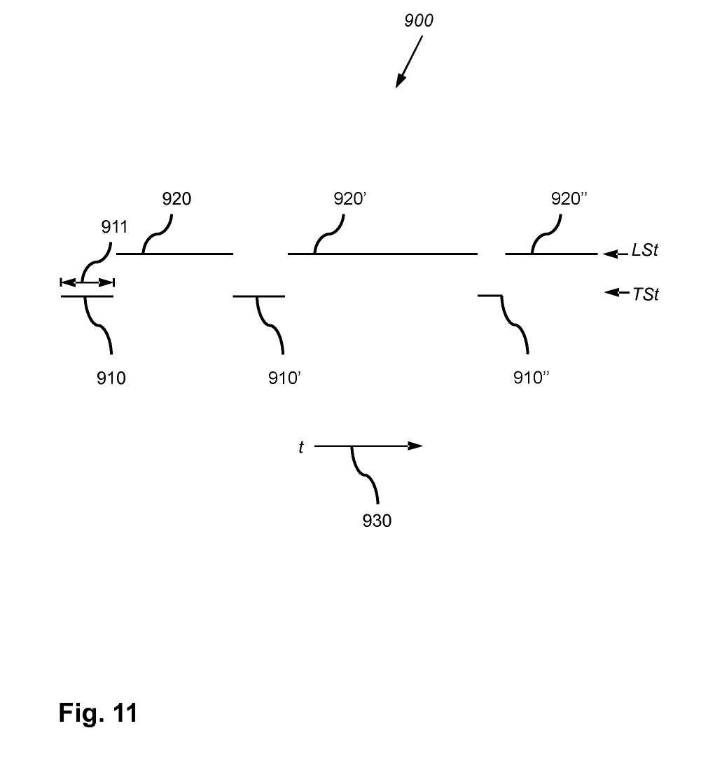

FIG. 11 schematically shows an example of state diagram 900 of an embodiment of token network. The state diagram comprises the transmission state (TSt) 910, 910′, 910″ and the listening state (LSt) 920, 920′, 920″. The state diagram shows further the progress of time direction 930. For the transmission state 910″ the preceding listening state 920′ is directly before this transmission state seen in the time. For the transmission state 910″ the next listening state 920″ is directly after this transmission state seen in the time. A transmission state period 911 is defined as the continuous period in time a master communication device is in the transmission state.

Master communication device for a token network. The token network comprises a shared communication medium and at least one further master communication device coupled to the shared communication medium, the token network being arranged to pass frames and to execute a poll for master cycle. The master communication device is restricted in executing a poll for master cycle in specified cases especially if another device executed a poll for master for finding a new master communication device on the token network.

It will be appreciated that the above description for clarity has described embodiments of the invention with reference to different functional units and processors. However, it will be apparent that any suitable distribution of functionality between different functional units or processors may be used without deviating from the invention. For example, functionality illustrated to be performed by separate units, processors or controllers may be performed by the same processor or controllers. Hence, references to specific functional units are only to be seen as references to suitable means for providing the described functionality rather than indicative of a strict logical or physical structure or organization. The invention can be implemented in any suitable form including hardware, software, firmware or any combination of these.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and the invention lies in each and every novel feature or combination of features described above or recited in mutually different dependent claims.

1. Master communication device for a token network, the token network comprising a shared communication medium and at least one further master communication device coupled to the shared communication medium, the token network having a master token chain providing a logic order of master communication devices in the token network, the token network being arranged to pass a master token along the master token chain and to pass frames and to execute a poll for master cycle, a next master communication device being downstream from the master communication device in the master token chain, a previous master communication device being upstream from the master communication device in the master token chain, the master communication device comprising:
a pass unit arranged to pass the master token to the next master communication device and set the master communication device in a listening state when passing the master token;
an accept unit arranged to accept the master token from the previous master communication device and set the master communication device in a transmission state when accepting the master token; and
a poll for master unit arranged to execute the poll for master cycle if the master communication device is in the transmission state, the poll for master cycle comprising at least one transmission of a poll for master frame to the token network, the poll for master unit being arranged to restrict said execution of the poll for master cycle when at least one poll for master frame was present on the shared medium during that the master communication device was in the listening state preceding the transmission state.

2. Master communication device according to claim 1, comprising a master token counter to hold a master token counter value,
the accept unit being arranged to increase the master token counter value when the accept unit accepts the master token;
the poll for master unit being further arranged to restrict said execution of a poll for master when the master token counter value is lower than a master token count threshold; and
the poll for master unit being arranged to reset the master token counter value after the poll for master cycle was executed.

3. Master communication device according to claim 1, comprising a detect unit arranged to detect a poll for master frame on the shared medium originating from a further master communication device if the master communication device is in the listening state.

4. Master communication device according to claim 3, the detect unit being arranged to decrease the master token counter value when the detect unit detects the poll for master frame.

5. Master communication device according to claim 3, comprising a poll for master skip flag;
the pass unit being arranged to reset the poll for master skip flag when the pass unit passes the master token;
the detect unit being arranged to set the poll for master skip flag when the detect unit detects the poll for master frame; and
the poll for master unit being further arranged to restrict the poll for master cycle when the poll for master skip flag is set.

6. Master communication device according to claim 1, comprising a poll for master token flag;
the accept unit being further arranged to set the poll for master token flag when the accept unit accepts a poll for master token from the shared medium;
the poll for master unit being further arranged to restrict the poll for master cycle when the poll for master token flag is not set; and
the pass unit being further arranged to reset the poll for master token flag when the pass unit passes the poll for master token to the shared medium destined for a further master communication device.

7. Master communication device according to claim 6;
the pass unit being arranged to pass the poll for master token and the master token in a single frame; and
the accept unit being arranged to accept the poll for master token and the master token in a single frame.

8. Master communication device according to claim 6;
the pass unit being arranged to pass the poll for master token and the master token in separate frames; and
the accept unit being arranged to accept the poll for master token and the master token in the separate frames.

9. Master communication device according to claim 1, the poll for master unit being arranged to split a poll for master cycle over a plurality of periods the master communication device is in the transmission state.

10. Master communication device according to claim 1, the master communication device being a BACnet MS/TP master network node.

11. Method for a poll for master cycle for a token network comprising a shared communication medium and at least one further master communication device coupled to the shared communication medium, the token network having a master token chain providing a logic order of master communication devices in the token network, the token network being arranged to pass a master token along the master token chain and to pass frames, a next master communication device being downstream from the master communication device in the master token chain, a previous master communication device being upstream from the master communication device in the master token chain, wherein the method comprises the steps of:
passing a master token to the next master communication device on the token network by a master communication device on the token network and thereby setting the master communication device in a listening state;
accepting the master token from the previous master communication device on the token network by the master communication device and thereby setting the master communication device in a transmission state; and
executing the poll for master cycle if the master communication device is in the transmission state, the poll for master cycle comprising at least one transmission of a poll for master frame to the token network, the poll for master unit being arranged to restrict said execution of the poll for master cycle when at least one poll for master frame was present on the shared medium in the listening state preceding the transmission state.

12. Integrated circuit device comprising a master communication device according to claim 1.

13. Computer program product for a processor arranged to a master communication device according to claim 1 or arranged to an integrated circuit device, which program is operative to cause the processor to perform the functions of the mentioned claims, or a processor arranged for execution.

14. A non-transitory tangible computer readable storage medium comprising data loadable in a programmable apparatus arranged to a master communication device or an integrated circuit device, which data representing instructions executable by the programmable apparatus, the instructions comprising one or more and partly or whole the functions or a programmable apparatus arranged for execution of the method of claim 11, the data representing instructions executable by the programmable apparatus.

15. Token network having a shared medium and arranged to execute a poll for master cycle comprising a plurality of master communication devices according to claim 1; at least one master communication device operating and at least one further master communication device; or at least one integrated circuit device coupled to the token network and at least one further master communication device.
